(19) United States
(12) Patent Application Publication
(10) Pub. No.: US 2025/0306892 A1
(43) Pub. Date: Oct. 2, 2025

(54) MOBILE BODY CONTROL DEVICE, MOBILE BODY CONTROL METHOD, AND STORAGE MEDIUM

(71) Applicant: HONDA MOTOR CO., LTD., Tokyo (JP)

(72) Inventors: Hisahiro Kato, Tokyo (JP); Hiroaki Hakukawa, Tokyo (JP); Satoshi Aiyoshizawa, Tokyo (JP)

(21) Appl. No.: 18/999,476

(22) Filed: Dec. 23, 2024

(30) Foreign Application Priority Data
Mar. 27, 2024 (JP) 2024-051651

(51) Int. Cl. G06F 8/65; G06F 8/71

(52) U.S. Cl. CPC G06F 8/65; G06F 8/71

(57) ABSTRACT

A mobile body control device includes software update units that execute an update process of software, and when executing the update process of the software, the software update units each write the software of a new version into a memory, and then writes function state information indicating a current state of a function of the mobile body into a prescribed storage area, before completing an activation process of the software of the new version.

### INCORPORATION BY REFERENCE

The present application claims priority under 35 U.S.C. § 119 to Japanese Patent Application No. 2024-051651 filed on Mar. 27, 2024. The content of the application is incorporated herein by reference in its entirety.

### BACKGROUND OF THE INVENTION

### Field of the Invention

The present invention relates to a mobile body control device, a mobile body control method, and a storage medium.

### Description of the Related Art

A technology to support software update has conventionally been proposed for control devices mounted on mobile bodies such as vehicles. For example, Japanese Patent Laid-Open No. 2019-144669 discloses a configuration in which a storage unit that stores a program executed by an electronic control unit (ECU) that is mounted on a vehicle has an area set for storing the program that is currently executed and an area set for storing an update program. According to the configuration, the update program can be stored in the storage unit even during execution of the program, which can reduce constraints on timing for program update.

Incidentally, when the functions and states of mobile bodies are reset to their initial values when the software is updated, the functions that have been operational while the mobile bodies have been parked may stop working while remaining parked, and the setting state of the mobile bodies may change between before and after the software update.

For example, vehicle security, which is an anti-theft function, operates when a vehicle is powered off and locked while the vehicle is parked. The security is set at the timing when the vehicle is locked by the user, and then if, the software is updated while the security is set, the security may unintentionally be unset after the software update. It is conceivable to maintain the state before the software update and take over the state after the software update, in which case, however, there may be prolonged downtime during which the security is temporarily disabled until the software is started and the takeover process is performed.

In order to solve the above issue, an object of this application is to reduce inoperable time of a mobile body as much as possible and to restrain malfunction and state change after software update. This in turn contributes to the development of sustainable transportation systems by further enhancing the safety of the traffic.

### SUMMARY OF THE INVENTION

One aspect of the present disclosure is a mobile body control device, including: a processor; a memory that stores software used by the processor; and a software update unit that executes an update process of the software, in which when executing the update process of the software, the software update unit writes the software of a new version into the memory, and then writes function state information indicating a current state of a prescribed function of the mobile body into a prescribed storage area, before completing an activation process of the software of the new version.

Another aspect of the present disclosure is a mobile body control method executed by a mobile body control device, including a processor, and a memory that stores software used by the processor, the method including, when executing the update process of the software, writing the software of a new version into the memory, and then writing function state information indicating a current state of a function of the mobile body into a prescribed storage area, before completing an activation process of the software of the new version.

A still another aspect of the present disclosure is a non-transitory computer-readable storage medium storing a program for causing at least some part of a mobile body control device, including a processor and a memory that stores software used by the processor, to function as a software update unit that executes an update process of the software, in which when executing the update process of the software, the software update unit writes the software of a new version into the memory, and then writes function state information indicating a current state of a function of the mobile body into a prescribed storage area, before completing an activation process of the software of the new version.

One aspect of the present invention makes it possible to reduce inoperable time of a mobile body as much as possible and to restrain malfunction and state change after software update.

### BRIEF DESCRIPTION OF THE DRAWINGS

FIG. 1 is a configuration diagram of a mobile body control device;

FIG. 2 is a timing chart of the software update process in the mobile body control device;

FIG. 3 shows an example of the state of the prescribed functions of the mobile body; and

FIG. 4 illustrates the operation of a second microcomputer when a central ECU makes a reset request.

### DETAILED DESCRIPTION OF THE INVENTION

### 1. Configuration of Mobile Body Control Device

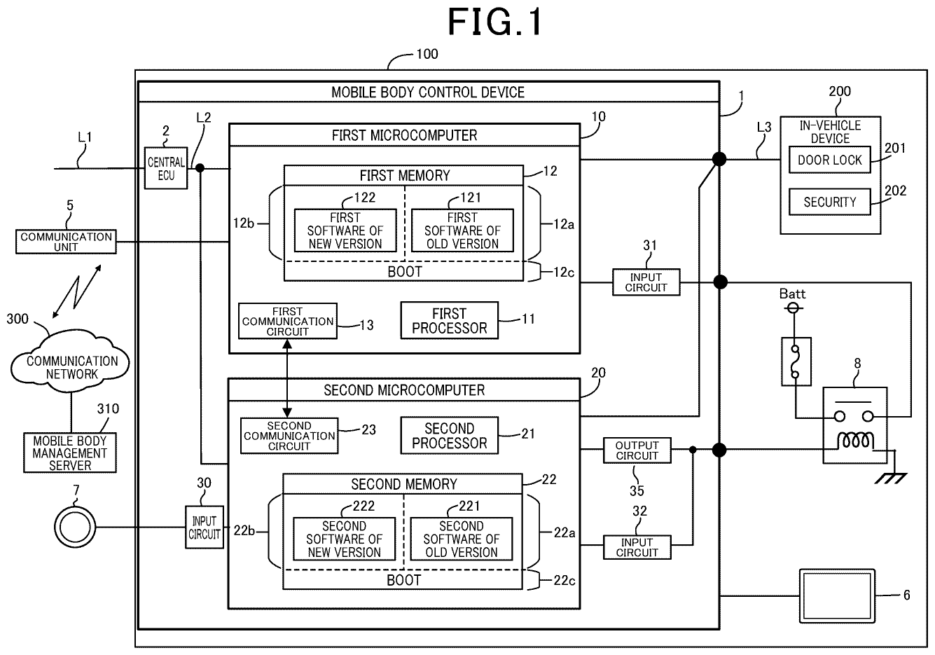

The configuration of a mobile body control device 1 of an embodiment will be described with reference to FIG. 1. The mobile body control device 1 includes a central ECU 2 that includes a processor and that performs overall control and information processing of a mobile body 100. In the present embodiment, the case where the mobile body 100 is a vehicle is illustrated, though the mobile body 100 is not limited to a vehicle and may be an aircraft, a ship, or the like.

The central ECU 2 is connected to a communication line including communication lines L1 to L3. The central ECU 2 is connected to a plurality of ECUs for controlling the operation of the mobile body 100 via the communication line to implement the function of a gateway that manages transfer of communication data. FIG. 1 shows, out of the plurality of ECUs, an area ECU that controls the operation of the functions (door lock and security) that are operable while the mobile body 100 is parked, and a peripheral configuration thereof.

The area ECU includes a first microcomputer 10 and a second microcomputer 20.

The communication line is a bus that performs communication in conformity with the standards of a controller area network ((CAN), registered trademark), a CAN with flexible data rate (CAN FD), a local interconnect network (LIN), an Ethernet (registered trademark), a FlexRay (registered trademark), or the like. Note that one of the communication lines L1 to L3 or the like may be used for communication that conforms to different standards.

The central ECU 2 writes software (programs), executed by the plurality of ECUs connected via the communication line and other ECUs connected via the ECUS, into the respective ECUs. The writing of software includes updating the software already written in the ECUs and writing new software into the ECUs.

This means that the central ECU 2 also functions as an over the air (OTA) manager that performs OTA management. The OTA management includes, for example, the process of downloading the software of an updated version of each ECU included in the mobile body 100 from an external server and the control related to the software update process.

The mobile body 100 includes a communication unit 5 that includes a transmitter and a receiver and that performs wireless communication with a mobile body management server 310 or the like via the communication network 300, and a display 6 that functions as a notification unit that notifies various information to a user (occupant) of the mobile body 100. Although the communication unit 5 and the display 6 are connected to the mobile body control device 1, they may be included in the mobile body control device 1.

The mobile body control device 1 is also connected to an in-vehicle device 200 mounted on the mobile body 100 via the communication line L3. The in-vehicle device 200 includes a configuration related to the functions that operate while the mobile body 100 is parked. In the present embodiment, the in-vehicle device 200 includes a door lock module 201 and a security module 202. The door lock module 201 and the security module 202 are connected to at least one of the first microcomputer 10 and the second microcomputer 20 via the communication line L3.

The first microcomputer 10 and the second microcomputer 20 execute controls and processes assigned to the area ECU. The first microcomputer 10 includes a first processor 11, a first memory 12, a first communication circuit 13, and the like. When the first processor 11 executes the first software stored in the first memory 12, operations such as locking or unlocking of the door lock module 201, and activating or deactivating headlights and wipers of the mobile body 100 are performed.

The second microcomputer 20 includes a second processor 21, a second memory 22, a second communication circuit 23, and the like. When the second processor 21 executes the second software stored in the second memory 22, operations such as controlling an electric power supply of the in-vehicle device 200, and setting the security module 202 are performed.

The controls and processes assigned to the respective microcomputers 10 and 20 may be changed as appropriate. In addition, the area ECU is not limited to the configuration including the two microcomputers 10 and 20, and may have a configuration including one microcomputer, or three or more microcomputers.

The mobile body 100 includes a start/stop (SS) switch 7 that can instruct switching between an ignition (IG) on (power on state) and IG off (power off state) of the mobile body 100.

As shown in FIG. 1, an operation signal of the SS switch 7 (on/off state of the SS switch 7) is input into the second microcomputer 20 via an input circuit 30. The first microcomputer 10 is connected to an IG relay 8 via an input circuit 31. In response to a control signal output from the second microcomputer 20 via the output circuit 35, on/off control of the IG relay 8 is performed, and the IG on and IG off of the mobile body 100 are switched.

An on/off detection signal of the IG relay 8 (on/off state of the IG relay 8) is input into the first microcomputer 10 via the input circuit 31 and is also input into the second microcomputer 20 via an input circuit 32.

The mobile body control device 1 updates the first software and the second software through the OTA management by performing wireless communication with the mobile body management server 310 via the communication network 300 using the communication unit 5.

Specifically, when first software 122 of a new version is downloaded from the mobile body management server 310, the central ECU 2 uses the first microcomputer 10 to update the first software. When second software 222 of a new version is downloaded from the mobile body management server 310, the central ECU 2 uses the second microcomputer 20 to update the second software.

The update process of the first software and the update process of the second software correspond to an example of the “update process of software that controls operation of a function maintained by the mobile body” in the present disclosure.

For the first memory 12 and the second memory 22 in the respective microcomputers 10 and 20, a rewritable dual bank ROM (two-sided ROM) is applied.

When first software 121 of an old version used by the first processor 11 is stored in one bank 12a of the first memory 12, downloaded first software 122 of a new version is written by the first processor 11 into the other bank 12b that is an unoccupied bank of the first memory 12.

When second software 221 of an old version used by the second processor 21 is stored in one bank 22a of the second memory 22, downloaded second software 222 of a new version is written by the second processor 21 into the other bank 22b that is an unoccupied bank of the second memory 22.

The first software 121 and the first software 122, each of which is software that can be used by the first processor 11, each include a control program for the mobile body 100, datasets used for controlling the mobile body 100, and the like. The first memory 12 includes an area 12c, where a boot (bootstrap) process program for the first microcomputer 10 is stored.

The second software 221 and the second software 222, each of which is software that can be used by the second processor 21, each include a control program for the mobile body 100, datasets used for controlling the mobile body 100, and the like. The second memory 22 includes an area 22c, where a boot (bootstrap) process program for the second microcomputer 20 is stored.

### 2. Software Update Timing

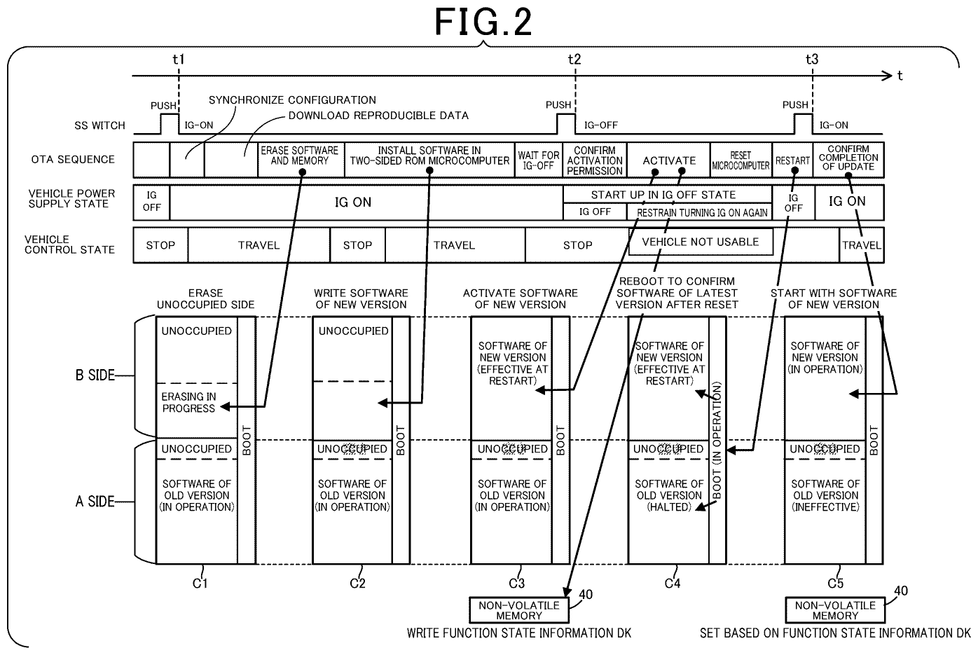

With reference to FIG. 2, update timing of the first software and the second software will be described. Since the update of the first software and the second software is performed at the same time by the same process, the first software and the second software are herein collectively referred to as the software, the first microcomputer 10 and the second microcomputer 20 are collectively referred to as the microcontroller, and the first memory 12 and second memory 22 are collectively referred to as the memory.

The first software is updated by executing the boot process program stored in the area 12c of the first memory 12 by the first processor 11. The second software is updated by executing the boot process program stored in the area 22c of the second memory 22 by the second processor 21.

Each of the microcomputers 10 and 20 functions as “software update unit” in the present disclosure, when the first processor 11 and the second processor 21 execute the respective boot process programs.

### 3. Operation of Mobile Body Control Device During Software Update

FIG. 2 shows a sequence of the software update process in time series along a time axis t. Upon recognition of IG on operation of the SS switch 7 at time t1, the mobile body control device 1 starts an OTA sequence to execute synchronizing configuration→downloading reproducible data (software data of a new version) from the mobile body management server 310→erasing software→installing software (installing software into the double-sided ROM microcomputer).

Note that FIG. 2 shows an example in which software update is performed through OTA when the mobile body control device 1 recognizes the IG on operation of the SS switch 7, though the software update may be performed at other times. For example, upon reception of a software update instruction signal transmitted from another ECU via the communication line 41, the mobile body control device 1 may perform the software update by OTA, that is, synchronizing configuration→downloading reproducible data (software data of a new version) from the mobile body management server 310→erasing software→installing software (installing software into the double-sided ROM microcomputer).

As denoted by reference signs C1 to C5 in FIG. 2, an area of the memory where the software of an old version before update is stored is referred to as an A side, and an area of the memory where the software of a new version after update is stored is referred to as a B side. Reference sign C1 denotes the situation where the B side that stores the software of the new version is erased, and the erased area becomes an unoccupied area in turn. In the A side, the software of the old version that is currently effective (in operation) is stored.

Next, the microcomputer starts writing the software of the new version into the B side, and waits for an IG off operation after writing is completed. Reference sign C2 denotes the situation where the software of the new version is written into the B side. At time t2, the microcomputer starts the activation process upon recognition of the IG off operation of the SS switch 7. The activation process includes confirming the permission of the user for activation, turning IG off, activating software, and resetting the microcomputer.

The microcomputer confirms the permission for activation (confirms update of software to a new version, etc.), and when the permission is confirmed, the microcomputer turns IG off (including setting to prohibit turning power on again), activates the software of the new version, and resets itself. Reference sign C3 denotes the situation where writing of the software of the new version into the B side is completed and the activation process is completed. When the microcomputer is restarted (equivalent to when the processor is restarted), the software of the new version becomes effective.

At time t3, upon recognition of the IG on operation of the SS switch 7, the microcomputer confirms that the update of the software from the old version to the new version is completed, and switches the software to be started from the old version to the new version. Reference sign C5 denotes the situation where the software started by the microcomputer when IG is turned on is switched from the software of the old version stored on the A side to the new version stored on the B side.

Here, when the functions and states of the mobile body 100 are reset to their initial values when the software is updated, the functions that have been operational while the mobile body 100 have been parked may stop working while remaining parked, and the setting state of the mobile body 100 may change between before and after the software update.

Accordingly, in the present embodiment, as shown in FIG. 2, the microcomputer writes the software of a new version into the memory, and then writes function state information DK indicating a current state of a prescribed function of the mobile body 100 into a non-volatile memory 40 that functions as a prescribed storage area, before completing an activation process of the software of the new version.

More specifically, in the case of updating the first software, the first microcomputer 10 writes the function state information DK, which indicates the state of the function (door lock) controlled by the first software, into the non-volatile memory 40 that is accessible by the first microcomputer 10.

Meanwhile, in the case of updating the second software, the second microcomputer 20 writes the function state information DK, which indicates the state of the function (security) controlled by the second software, into the non-volatile memory 40 that is accessible by the second microcomputer 20.

For the non-volatile memory 40, writable non-volatile memories other than first memory 12 and second memory 22 can widely be applied.

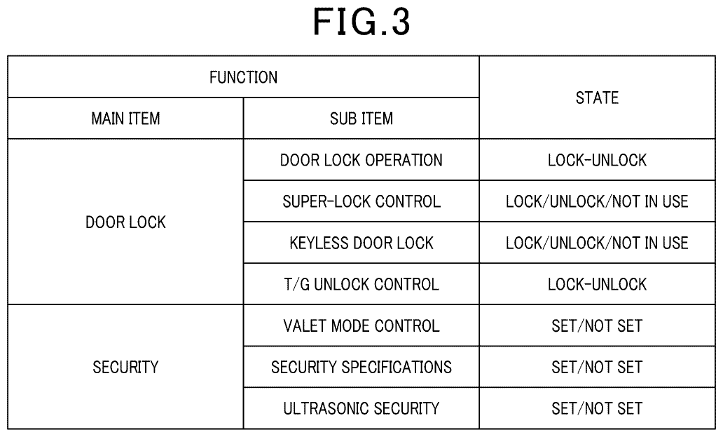

FIG. 3 shows an example of the state of the prescribed functions of the mobile body 100.

The door lock and the security are functions that may operate while the mobile body is parked and are examples of the “prescribed function” in the present disclosure.

As shown in FIG. 3, there are four types of door lock, namely, door lock operation, super-lock control, keyless door lock, and unlock control of a trunk (T) and a glove box (G). The states of each function include, for example, locked, unlocked, and not in use.

The door lock operation is the function that locks or unlocks the doors of the mobile body 100, and locking the doors improves safety and security. The super-lock control, which is an extended version of a typical door lock function, is the function that provides greater security than the case where the typical door lock is used for locking.

The keyless door lock is the function that locks and unlocks the doors using remote control or a keyless entry system. The unlock control of the trunk (T) and the glove box (G) is the function that prohibits each of the trunk and the glove box from being unlocked.

As shown in FIG. 3, there are three types of security, namely, valet mode control, security specifications, and ultrasonic security. The states of each function include, for example, set/not set.

The valet mode control is a type of the security system of the mobile body 100. For example, when the valet mode control is effective, only authorized users are allowed to use the functions of the vehicle. The security specifications indicate specifications and standards related to the security function of the mobile body 100. Examples of the security specifications include an immobilizer, and a theft alarm system. The ultrasonic security is a security system using ultrasonic waves.

For the door lock and the security, locked, unlocked, not in use, set, not set, and the like, are set according to preset specifications or a user's choice.

In the present embodiment, information indicating the state of the functions, which is the latest at the time of writing into the non-volatile memory 40, is written into the non-volatile memory 40 as the function state information DK. Specifically, after the software of a new version is written into the memory, the function state information DK at the time point before completion of the activation process of the software of the new version is written into the non-volatile memory 40. As a result, the function state information DK immediately before the software update is recorded.

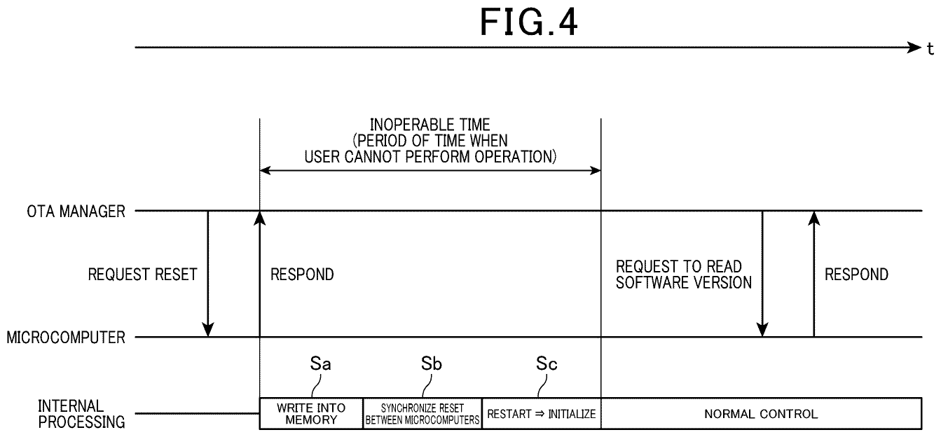

With reference to FIG. 4, the operation of the microcomputer when the central ECU 2 makes a reset request to the microcomputer will be described.

When the microcontroller receives a reset request from the central ECU 2 and responds to the request, the microcomputer writes the function state information DK into the non-volatile memory 40 (step Sa). The microcomputer then performs a process to synchronize the reset between the first microcomputer 10 and the second microcomputer 20 using a communication circuit such as the first communication circuit 13 and the second communication circuit 23 (step Sb), and then restarts the microcomputer (step Sc). The restart makes the software of the new version effective.

As shown in FIG. 2, when the microcomputer is restarted with the software of the new version, the microcomputer sets the state of the functions, which operate while the mobile body is parked, in the software or the like, based on the function state information DK written in the non-volatile memory 40. This can ensure that the state of the functions that operate while the mobile body 100 is parked remains unchanged.

Here, as shown in FIG. 4, a period of time between the steps Sa to Sc corresponds to inoperable time (the period of time when the user cannot perform operation). In the present embodiment, the software update can immediately be performed regardless of the current state of the functions of the mobile body 100. When the software is updated, the state of the functions of the mobile body 100 is immediately set based on the function state information DK, which makes it possible to reduce the inoperable time as much as possible.

As described in the foregoing, in the case of executing the update process of software, the mobile body control device 1 of the present embodiment writes the software of a new version into the memory using the microcomputer, and then writes the function state information DK indicating the current state of the prescribed functions (door lock and security) of the mobile body 100 into the non-volatile memory 40 that functions as a prescribed storage area, before completing the activation process of the software of the new version.

Therefore, when the software is updated, the state of the prescribed functions of the mobile body 100 can be set based on the function state information DK. Moreover, the software update can immediately be performed regardless of the current state of the functions of the mobile body 100. As a result, it becomes possible to reduce downtime of the mobile body 100 as much as possible and to restrain malfunction and state change after software update. This in turn contributes to the development of sustainable transportation systems by further enhancing the safety of the traffic.

The mobile body control device 1 also includes a plurality of ECUs (which may also be called processors) including the ECU including the microcomputers 10 and 20. The microcomputers 10 and 20 write the function state information DK into the non-volatile memory 40 after starting the activation process and before the target ECU (processor) is restarted. This makes it possible to restrain malfunction and state change after the software update.

Moreover, the non-volatile memory 40 is a recording area of another memory different from the memory where software is stored, which allows smooth rewriting of the software.

The microcomputer also sets the state of the prescribed functions based on the function state information DK after restarting with the software of the new version, which makes it possible to restrain malfunction and state change after the software update.

In addition, the mobile body control device 1 writes the function state information DK into the non-volatile memory 40 in the case of executing the update process of the software that controls the operation of the mobile body 100, including the function maintained by the mobile body 100 (for example, at least one of the door lock and the security) while the mobile body 100 is parked. This makes it possible to keep the state of the mobile body 100 unchanged even when the software is updated while the mobile body 100 is parked.

Note that that the present invention may not be limited to the update process of the software that controls the operation of the mobile body 100, the operation including the function maintained by the mobile body 100 while the mobile body 100 is parked. In other words, the present invention may write the function state information DK into the non-volatile memory 40 in the case of executing the update process of the software that controls the operation of the function maintained by the mobile body 100. This makes it possible to keep the state of the mobile body 100 unchanged even when the software is updated.

Here, when the microcomputer detects user operation for the mobile body 100 upon reception of a reset request shown in FIG. 4, it is preferable to postpone (suspend) the software update process. This makes it possible to avoid the situation where the software update process is performed while the user is changing the state of a prescribed function, and to thereby keep the state of the prescribed function unchanged even when the software is updated.

### 4. Other Embodiments

The embodiment described above is merely one embodiment of the present invention, and any deformations and applications are possible without departing from the concept of the present invention.

The configuration of the mobile body control device 1 shown in FIG. 1 is exemplary, and the configuration may be changed as appropriate. FIG. 1 is an illustrative diagram in which the configuration of the mobile body control device 1 is categorized and shown according to main processing contents for easy understanding of the present invention, and therefore, the mobile body control device 1 may be configured according to other categories. The processing of each component member may be executed by a single hardware unit or may be executed by a plurality of hardware units. The processing by each component member may be executed by a single program or may be executed by a plurality of programs.

### 5. Configurations Supported by Above Embodiment

The embodiment disclosed is a specific example of the following configurations.

(Configuration 1) A mobile body control device, including: a processor; a memory that stores software used by the processor; and a software update unit that executes an update process of the software, in which when executing the update process of the software, the software update unit writes the software of a new version into the memory, and then writes function state information indicating a current state of a prescribed function of the mobile body into a prescribed storage area, before completing an activation process of the software of the new version.

The mobile control device of configuration 1 can set the state of a prescribed function of the mobile body based on the function state information when the software is updated. Moreover, the software update can immediately be performed regardless of the current state of the function of the mobile body. This makes it possible to reduce downtime of the mobile body as much as possible and to restrain malfunction and state change after software update.

(Configuration 2) The mobile body control device according to configuration 1, including a plurality of processors including the processor, in which the software update unit writes the function state information into the storage area after the activation process is started and before the processor is restarted.

This makes it possible to restrain malfunction and state change after the software update.

(Configuration 3) The mobile body control device according to configuration 1 or 2, in which the storage area is a storage area of another memory different from the memory.

The mobile control device of configuration 3 allows smooth rewriting of the software.

(Configuration 4) The mobile body control device according to any one of configurations 1 to 3, in which after restarting with the software of the new version, the processor sets the state of the prescribed function based on the function state information.

The mobile body control device of configuration 4 makes it possible to restrain malfunction and state change after the software update.

(Configuration 5) The mobile body control device according to any one of configurations 1 to 4, in which when executing an update process of software that controls operation of a function maintained by the mobile body, the software update unit writes the function state information into the storage area.

The mobile body control device of configuration 5 makes it possible to keep the state of the mobile body unchanged even when the software is updated.

(Configuration 6) The mobile body control device according to any one of configurations 1 to 5, in which when detecting user operation for the mobile body upon reception of a reset request related to the update process of the software, the software update unit postpones the update process of the software.

The mobile body control device of configuration 6 makes it possible to avoid the situation where the software update process is performed while the user is changing the state of the prescribed function, and to thereby keep the state of the prescribed function unchanged even when the software is updated.

(Configuration 7) A mobile body control method executed by a mobile body control device, including a processor, and a memory that stores software used by the processor, the method comprising, when executing the update process of the software, writing the software of a new version into the memory, and then writing function state information indicating a current state of a prescribed function of the mobile body into a prescribed storage area, before completing an activation process of the software of the new version.

When the mobile body control method of configuration 7 is executed by the mobile body control device, the operational effects similar to those of the mobile body control device of configuration 1 can be obtained.

(Configuration 8) A program for causing at least some part of a mobile body control device, including a processor and a memory that stores software used by the processor, to function as a software update unit that executes an update process of the software, in which when executing the update process of the software, the software update unit writes the software of a new version into the memory, and then writes function state information indicating a current state of a prescribed function of the mobile body into a prescribed storage area, before completing an activation process of the software of the new version.

When the program of configuration 8 is executed by the mobile body control device, the operational effects similar to those of the mobile body control device of configuration 1 can be obtained.

### REFERENCE SIGNS LIST

1 Mobile body control device, 2 Central ECU, 5 Communication unit, 6 Display, 7 SS switch, 8 IG relay, 10 First microcomputer, 11 First processor, 12 First memory, 13 First communication circuit, 20 Second microcomputer, 21 Second processor, 22 Second memory, 23 Second communication circuit, 30, 32, 33 Input circuit, 35 Output circuit, 40

Non-volatile memory (prescribed storage area), 100

Mobile body, 121 First software of old version, 122 First software of new version, 200 In-vehicle device, 201 Door lock module, 202 Security module, 221 Second software of old version, 222 Second software of new version, 300 Communication network, 310 Mobile body management server.

1. A mobile body control device, comprising:
a processor;
a memory that stores software used by the processor; and
a software update unit that executes an update process of the software, wherein
when executing the update process of the software, the software update unit writes the software of a new version into the memory, and then writes function state information indicating a current state of a prescribed function of the mobile body into a prescribed storage area, before completing an activation process of the software of the new version.

2. The mobile body control device according to claim 1, comprising a plurality of processors including the processor, wherein
the software update unit writes the function state information into the storage area after the activation process is started and before the processor is restarted.

3. The mobile body control device according to claim 1, wherein
the storage area is a storage area of another memory different from the memory.

4. The mobile body control device according to claim 1, wherein
after restarting with the software of the new version, the processor sets the state of the prescribed function based on the function state information.

5. The mobile body control device according to claim 1, wherein
when executing an update process of software that controls operation of a function maintained by the mobile body, the software update unit writes the function state information into the storage area.

6. The mobile body control device according to claim 1, wherein
when detecting user operation for the mobile body upon reception of a reset request related to the update process of the software, the software update unit postpones the update process of the software.

7. A mobile body control method executed by a mobile body control device, including a processor, and a memory that stores software used by the processor, the method comprising,
when executing the update process of the software, writing the software of a new version into the memory, and then writing function state information indicating a current state of a prescribed function of the mobile body into a prescribed storage area, before completing an activation process of the software of the new version.

8. A non-transitory computer-readable storage medium storing a program which is executed by a processor for causing at least some part of a mobile body control device, including a processor and a memory that stores software used by the processor, to function as a software update unit that executes an update process of the software, wherein
when executing the update process of the software, the software update unit writes the software of a new version into the memory, and then writes function state information indicating a current state of a function of the mobile body into a prescribed storage area, before completing an activation process of the software of the new version.
